(19) United States
(12) Patent Application Publication
(10) Pub. No.: US 2025/0366954 A1
(43) Pub. Date: Dec. 4, 2025

(54) MAGNETIC DRIVE SYSTEM FOR DENTAL APPLICATIONS AND METHODS

(71) Applicant: Anne Simonsen, Carmel, CA (US)

(72) Inventor: Anne Simonsen, Carmel, CA (US)

(21) Appl. No.: 18/866,912

(22) PCT Filed: May 18, 2023
(86) PCT No.: PCT/US2023/067157

§ 371 Date: Nov. 18, 2024

Related U.S. Application Data
(60) Provisional application No. 63/343,238, filed on May 18, 2022.

(51) Int. Cl. A61C 8/00

(52) U.S. Cl. CPC A61C 8/0012; A61C 8/0089

(57) ABSTRACT

A dental screw used to secure a dental structure, such as a crown, abutment, or coping, to an implant fixture within the jawbone of a dental patient. The dental screw has magnetic properties suitable for allowing the dental screw to be magnetically attracted to a corresponding driver such that magnetic attraction encourages the screw to maintain engagement with the driver during screw insertion and removal procedures.

### CROSS-REFERENCE TO RELATED APPLICATION

This application is being file on May 18, 2023, as a PCT International Application and claims the benefit of a U.S. Provisional Application Ser. No. 63/343,238, filed May 18, 2022, the disclosure of which is hereby incorporated by reference in its entirety.

### BACKGROUND

When natural teeth are lost or damaged as a result of trauma or disease, a replacement may be desirable. Screw-retained crowns are one possible option where an implant fixture is placed into the jawbone of a patient, in place of the root of the lost tooth. Through a series of additional procedures, a new crown is shaped and sized appropriately for the opening and mounted to an abutment or other dental structure. The abutment is then seated onto the implant fixture and held in place by a screw. These screws, commonly referred to as retention or fixation screws, can be placed through an opening in the crown and threaded into the implant fixture.

Under certain conditions, dental screws may require removal. Example reasons necessitating the removal of a dental screw include fitting of the implant crown, try-in, patient wear, incomplete threading, overtightening, stripping, or even breaking of the screw. When the drive socket of the screw or the threads are partially stripped, safe removal can be difficult. The handling of a dental screw is typically done with a small hand driver that friction fits into the drive socket of the screw. At times the driver may not be able to seat entirely onto the drive socket of the screw due to the limited space and position of the implant fixture in a patient's mouth. Manufacturing variance and wear can further worsen the fit of the driver in the drive socket. These challenges increase the likelihood of the screw falling from the driver during insertion into or removal from a patient's mouth. It is therefore desirable to have a dental screw that is easier and safer to handle, both during insertion and removal.

### SUMMARY

Aspects of the present disclosure relate to systems, methods, assemblies, components, and screw configurations for facilitating the safe and reliable use of dental screws during prosthetic try-in, implantation, and removal procedures. In certain examples, the dental screws have magnetic properties suitable for allowing the screws to be magnetically attracted to corresponding drivers such that magnetic attraction encourages the screws to maintain engagement with the drivers during screw insertion and removal procedures. Magnetic screws assist in preventing screws from falling into patient's mouths and assist with the removal of partially stripped or otherwise damaged screws. Hence, the use of magnetic screws provides an important advancement in the area of dental prosthesis.

One aspect of the present disclosure relates to a screw for securing a dental structure to an implant fixture within the jawbone of a dental patient. The screw includes a main body having a first end including a head defining a drive socket. The main body also has a second end including a tip and a shank extending from the head to the tip. At least a portion of the shank is threaded. The screw further includes a magnetic element carried with the main body. In certain examples, the main body of the screw has a material composition that is non-magnetic and biocompatible such as titanium or gold. In certain examples, the main body of the screw has a magnetic material composition. In certain examples, the magnetic element is plated on the main body, adhesively bonded to the main body, welded to the main body, encapsulated within the main body, inset within the main body, or otherwise secured to the main body. In certain examples, the magnetic element is located at the head of the main body (e.g., within the drive socket).

Another aspect of the present disclosure relates to a method for handling a screw used to secure a dental structure to an implant fixture within the jawbone of a dental patient. The method includes the step of inserting the screw into the dental structure within the patient's mouth or removing the screw from the dental structure within the patient's mouth while the screw is retained at the tip of a hand driver at least partially by magnetic attraction between the screw and the tip of a hand driver.

A further aspect of the present disclosure relates to a dental assembly including a magnetic dental screw, an implant fixture, and a dental structure adapted to be secured to the implant fixture by the dental screw. In certain examples, the dental structure is a crown, abutment, implant bridge, coping, analog, healing collar, cuff, or other dental prostheses. In certain examples, the dental screw is used with a mating magnetic hand driver. In certain examples, the screw includes a main body having a head and a threaded shank, and also includes a magnetic element carried with the main body. In one example, the magnetic element is positioned at the head of the screw. In certain examples, two or more components of the dental assembly can be incorporated as part of a dental kit.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is an exploded view of a dental assembly in accordance with the principles of the present disclosure, the dental assembly includes a magnetic screw, a dental structure, and an implant fixture depicted aligned along a coronal/apical axis.

FIG. 2 is a longitudinal cross-sectional view of the implant fixture of the dental assembly of FIG. 1.

FIG. 3 is a cross-sectional view of the dental assembly of FIG. 1, where the implant fixture is positioned in the jawbone of a patient.

FIG. 4 is a longitudinal cross-sectional view of the dental structure of the dental assembly of FIG. 1, where the dental structure is depicted as an abutment.

FIG. 5 is a cross-sectional view of a completed screw-retained crown, where a crown is secured with respect to the jawbone of a patient by the dental assembly of FIG. 1.

FIG. 6 is a side view of the magnetic screw of the dental assembly of FIG. 1.

FIG. 7 is a longitudinal cross-sectional view of the screw of FIG. 6 showing magnetic plating at a head of the magnetic screw.

FIG. 8 is a top view of the magnetic screw of FIG. 6.

FIG. 9 depicts the magnetic screw of the dental assembly of FIG. 1 aligned with a corresponding hand driver having a tip adapted to mate in torque-transferring engagement with the head of the screw.

FIG. 10 is a longitudinal cross-sectional view of another magnetic dental screw in accordance with the principles of the present disclosure that is usable with the dental assembly of FIG. 1.

FIG. 11 is a longitudinal cross-sectional of an additional magnetic dental screw in accordance with the principles of the present disclosure that is usable with the dental assembly of FIG. 1.

FIG. 12 is a top view of the magnetic screw of FIG. 11.

FIG. 13 is a perspective view showing the screw-retained crown of FIG. 5 seated within a patient's mouth, the magnetic screw is shown in the process of being inserted into the screw-retained crown and is depicted engaged with the driver of FIG. 9.

### DETAILED DESCRIPTION

Various embodiments will be described in detail with reference to the drawings, wherein like reference numerals represent like parts and assemblies throughout the several views. Any examples set forth in this description are not intended to be limiting and merely set forth some of the many possible embodiments within the scope of the present disclosure.

Aspects of the present disclosure relate to dental assemblies and components of dental assemblies that are used to surgically replace teeth when lost or damaged. An example dental assembly can include: an implant fixture, a dental structure, and a dental screw. The implant fixture is adapted to be installed into the jawbone of a patient, taking the place of the root of a tooth, to provide a linkage from the jaw to the tooth replacement structure. The dental structure can be secured to the implant fixture by the dental screw. Common dental structures include screw-retained crowns, full-arch dental prostheses, abutments, implant bridges, copings, analogs, healing collars, cuffs, and other dental prostheses. In one example, a crown or bridge can be integrated with an abutment, and a dental screw can be used to secure the crown or bridge and the abutment to an implant fixture. In another example, a dental screw can be used to secure an abutment to an implant fixture, and a crown or bridge can be bonded on the abutment. In certain examples, dental screws can be used to secure two dental structures together. For example, a first dental screw can be used to secure an abutment to an implant fixture and a second dental screw can be used to secure a crown or bridge to the abutment.

Aspects of the present disclosure also relate to the use of magnetic attraction to enhance the engagement between a dental screw and the tip of a hand driver. It will be appreciated that hand drivers are used to insert and remove dental screws during dental implant procedures. The tip of the hand driver is adapted to engage the head of a dental screw in a torque-transferring relationship such that the hand driver can be used to apply torque to the dental screw to drive the dental screw into an installed position during an implantation procedure or to unthread the dental screw during a removal procedure. Friction between the tip of the hand driver and the head of the dental screw can assist in retaining the screw on the tip of the hand driver during screw insertion and removal. However, friction alone can, at times, be insufficient to reliably retain the screw on the tip of the driver. For example, under certain conditions, the initial fit between the hand driver and the screw may be loose in which case magnetic attraction between the dental screw and the driver can assist in preventing the dental screw from disengaging from the driver during insertion of the dental screw into the patient's mouth or removal from the patient's mouth. Also, when a dental screw is initially installed, contact between the driver and the screw during torquing of the screw may loosen the fit between the driver and the dental screw. When this occurs and it is necessary to later remove the dental screw, magnetic attraction between the dental screw and the driver can greatly assist in removing (e.g., lifting, pulling) the dental screw from its corresponding dental structure.

Another aspect of the present disclosure relates to improved screws used in dental implantation applications. Such screws may be used in any number of applications such as screw-retained crowns, abutments, implant bridges, copings, analogs, healing collars, cuffs, and other dental prostheses. In certain examples, the screws are made easier and safer to handle by the addition of magnetic elements. In certain examples, the screws include main bodies made from gold or titanium in order to maintain biocompatibility and prevent galvanic corrosion between the screw and the implant fixture or the screw and the dental structure. The magnetic elements are added to the main bodies of the screws to reduce the likelihood for a screw to unintentionally disengage from the driver during insertion or removal. Furthermore, when the drive socket of a screw is partially stripped, the magnetic attraction makes removal easier. The magnetic element may be positioned anywhere in or on the screw, such that the screw has some magnetic attraction to a magnetic driver when the driver is inserted into the drive socket of the screw. Because some of these screws must pass-through close-fitting holes within crowns or other dental structures, other means of retaining the screw to the driver may not be suitable. For instance, a collet provided on the driver for engaging an outside of the screw would prevent the screw from passing into the desired area.

In certain examples, the magnetic elements can be layered onto the main bodies of the screws. Nickel is a ferromagnetic material that can be plated onto gold. In one example of the present disclosure, the main body of a dental screw can be manufactured having a material composition including gold, and a material including nickel can be plated on the main body to provide the screw with magnetic properties. Plating on the head and in the drive socket of the screw provides the most direct path between the magnetic element of the screw and the magnetic driver to be used in conjunction with the screw.

Depending on the application, it may be desirable to encapsulate the magnetic elements of the screws (e.g., plating, inserts, etc.) with a material that is already customary or approved for use in dental applications such as gold or titanium so that the magnetic elements are not exposed. Multiple plating steps may be performed to first plate the desired area of the magnetic element and then plate over the magnetic element with another preferred metal. The main body of the screw may be made of a magnetic element with a biocompatible plating used to encapsulate the entirety of the screw or at least a portion of the screw.

Another aspect of present disclosure relates to magnetic elements (e.g., inserts) that are fixed to a screw (e.g., inset within the head of a screw). It is possible to locate a magnetic element in the drive socket of a screw such that the magnetic element is in direct contact with a driver when the driver is inserted into the drive socket. A magnetic element may be fixed to a screw in any number of ways. In one example an adhesive is used. In another example, the magnetic element is welded to the screw or press-fit within the screw.

Another aspect of the present disclosure relates to methods of using a magnetic screw. A magnetic screw may be used with a magnetic driver such that there is a magnetic attraction between the driver and the screw. The magnetic attraction at least partially helps retain the screw to the driver during insertion and removal of the screw. The screw is inserted by placing the screw onto the tip of the driver and then placing the driver into the through hole created by, for instance, a crown. Once the tip of the screw reaches the threaded opening of the implant fixture, it is threaded into place through torque-transferring engagement with the driver. The magnetic attraction is then overcome by the holding force of the threads and the driver is removed. When the screw is unthreaded, it can be removed, at least partially by magnetic attraction between the screw and the driver.

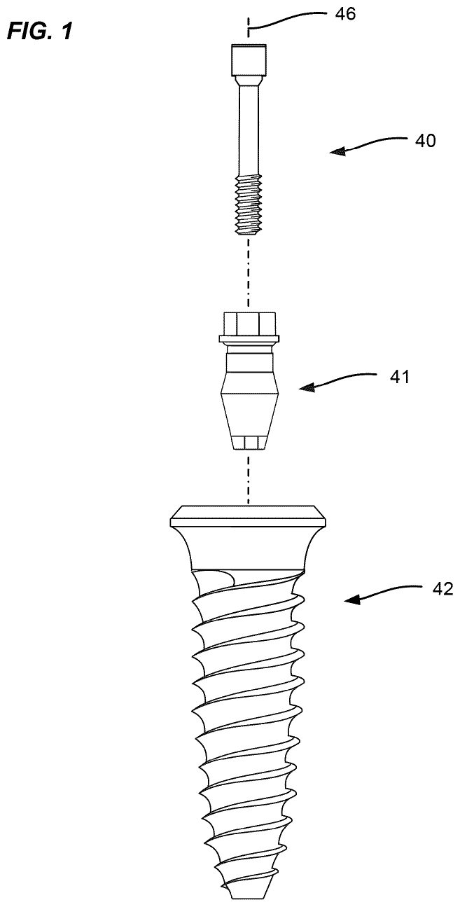

FIG. 1 depicts a dental assembly in accordance with the principles of the present disclosure including a retaining screw 40 used to secure a dental structure, in this case an abutment 41, to an implant fixture 42. The retaining screw 40 is an example of a dental screw and has magnetic properties in accordance with the principles of the present disclosure.

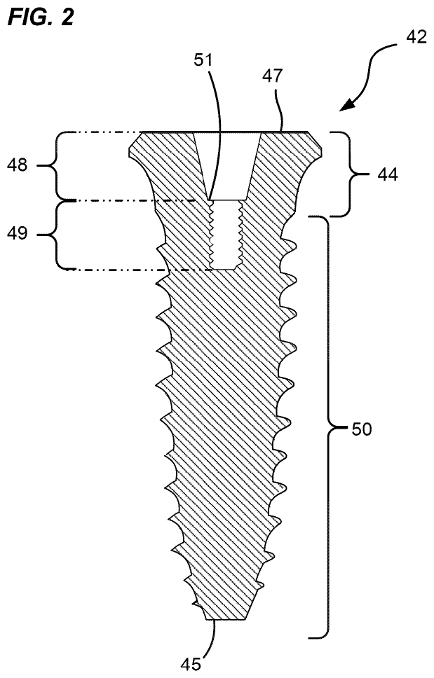

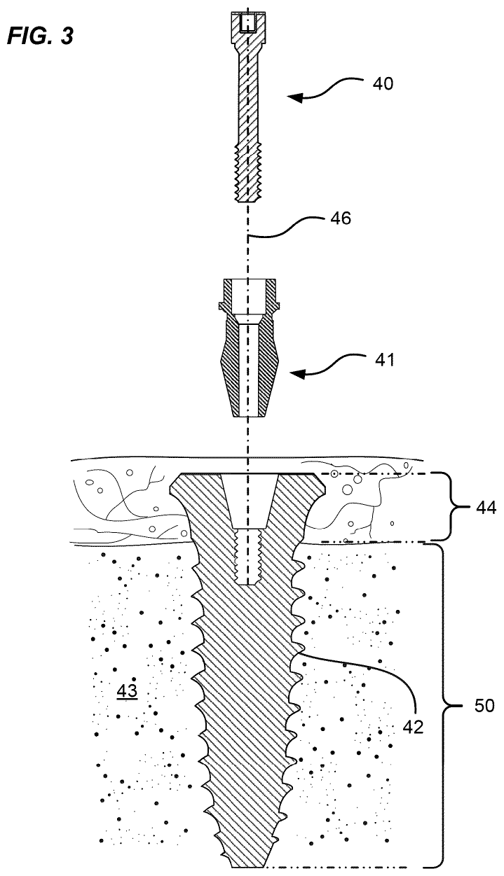

FIG. 2 shows a cross section of the implant fixture 42. The implant fixture 42 is one example of a variety of implants meant to engage the jawbone of a patient. The implant fixture 42 may be many different shapes including threaded, tapered, cylindrical, rounded, curved, and combinations thereof. The implant fixture 42 can be made of titanium but may be made from any biocompatible material with sufficient strength. In use, the implant fixture 42 is surgically placed in a jawbone 43 such that it engages the surrounding bone. The implant fixture 42 acts as the root of a tooth and serves as the base for the abutment 41 or other dental structure. FIG. 3 depicts the implant fixture 42 positioned in the jawbone 43 of a patient. When surgically installed into the dental patient's jawbone 43, the implant fixture 42 sits in line with the neighboring roots such that there is a coronal top portion 44 positioned generally at the gum line and an apical bottom end 45 terminating in the jawbone 43 (e.g., the alveolar). A coronal/apical axis 46 runs from the coronal top portion 44 and down through an apical bottom portion 50 where the axis is centered on a coronal top exterior surface 47 of the implant fixture 42.

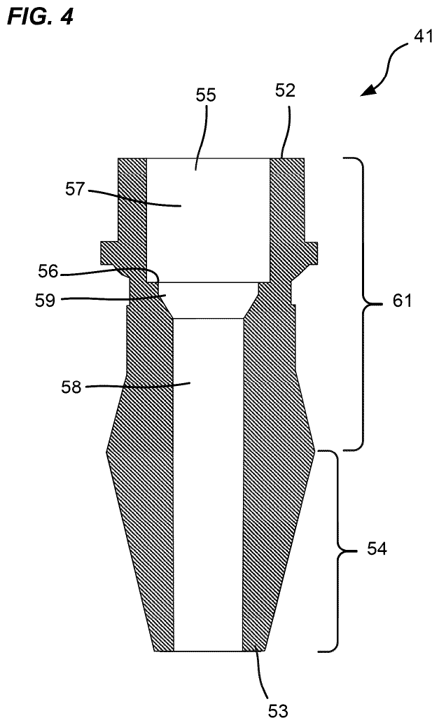

Referring back to FIG. 2, the apical bottom portion 50 is intended to contact the jawbone 43. The apical bottom portion 50 may be threaded to increase retention in the jawbone 43 and to promote bone growth of the jawbone 43 around the implant fixture 42. The coronal top exterior surface 47 is intended to seat the dental structure and receive the screw 40. The coronal top exterior surface 47 may have a seating recess 48 (e.g., a polygon-shaped recess such as a hexagonal-shaped recess) intended to mate with a bottom portion 54 (see FIG. 4) of the abutment 41. For example, the seating recess 48 on the coronal top exterior surface 47 of the implant fixture 42 may be used to seat the bottom portion 54 of the abutment 41. The seating recess 48 helps to prevent unwanted rotation of the seated abutment 41. The seating recess 48 may extend toward the apical bottom end 45. A base 51 of the seating recess 48 may form the beginning of a threaded cavity 49 intended to engage the threads of the retaining screw 40 and extending further toward the apical bottom end 45 of the implant fixture 42. The threaded cavity 49 forms a generally circular top opening centered about the coronal/apical axis 46 and located at the base 51 of the seating recess 48. The threaded cavity 49 continues from the circular top opening toward the apical bottom end 45 of the implant fixture 42 to form a generally cylindrical threaded cavity 49. The side walls of the cavity 49 are internally threaded to engage with the external threading of the screw 40. When the retaining screw 40 is fully threaded into the implant fixture 42, the abutment 41 is held in place.

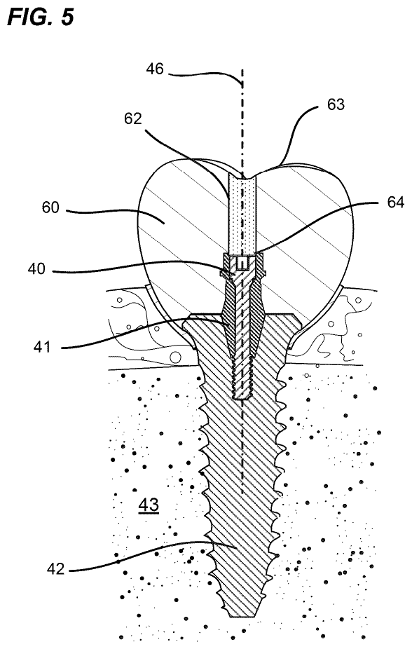

FIG. 4 shows a cross section of the abutment 41. The abutment 41 is one example of a dental structure that may be adapted to a number of exterior shapes in order to align a crown (e.g., crown 60 shown at FIGS. 5 and 13) or other prostheses with surrounding teeth. For example, the exterior shape may be cylindrical, conical, tapered, curved, angled, or combinations thereof. Many different commercially available abutments exist, and an embodiment of the present disclosure is intended to be compatible with these designs. For example, UCLA and Titanium abutments are commonly used.

Referring still to FIG. 4, the abutment 41 has a coronal top end 52 and an apical bottom end 53 where the bottom end 53 contacts the implant fixture 42. A cavity 55 runs through the length of the abutment 41 from the top end 52 through the bottom end 53. The cavity 55 forms a generally circular opening at the top end 52 and a generally cylindrical through hole. When installed into the implant fixture 42, the coronal/apical axis 46 runs through the center of the generally circular opening at the top end 52 and through the center of the generally circular opening at the bottom end 53. The cavity 55 may be threaded to receive a retaining screw 40 but more commonly, the cavity 55 is unthreaded. The edge of the circular opening may form a shoulder 56 for a bottom end 78 (see FIG. 7) of a head 67 of the screw 40 to seat against.

As depicted at FIG. 4, the circular opening may also be stepped such that the cavity 55 forms two areas. A first area 57 begins at the top end 52 of the abutment 41 and continues toward the bottom end 53 for a length generally greater than the screw head height. The first area 57 may have a diameter greater than the head diameter of the screw 40. A second area 58 continues from the apical end of the first area 57 and extends through the bottom end 53. In some embodiments, a curved or tapered transition 59 may be formed between the first area 57 and the second area 58, such that the shape generally matches the transition from the head 67 to a shank 71 of the screw 40 (see FIG. 7). The transition 59 may form the shoulder 56 for the bottom end 78 of the head 67 of the screw 40 to seat against. The second area 58 has a smaller diameter than the first area 57. The second area 58 may have a diameter larger than the diameter of the shank 71 of the screw 40 but smaller than the head diameter of the screw 40.

The bottom portion 54 of an abutment 41 may be sized and shaped to mate with and fit into the seating recess 48 on the implant fixture 42. The shaped bottom portion 54 helps prevent rotation about the coronal/apical axis 46. The bottom portion 54 of the abutment 41 may be curved, tapered, or otherwise shaped to fit into the implant fixture 42. FIG. 4 shows the bottom portion 54 being tapered to form the exterior of a frustum of a hexagonal pyramid shape. The bottom portion is intended to match the shape of the seating recess 48 in the implant fixture 42. Further, the abutment 41 may sit on the implant fixture 42 such that the screw shank 71 may pass through the second area 58 of the abutment 41 and into the threaded cavity 49 on the implant fixture 42. When the screw 40 is tightened onto the implant fixture 42, the bottom end 78 of the screw head 67 seats onto the shoulder 56 formed by the step between the first area 57 and second area 58 of the abutment cavity 55. The abutment 41 also has an upper exterior portion 61. The upper exterior portion 61 may vary in shape, angle, size, and combinations thereof. The upper exterior portion 61 generally provides a surface for securing crowns 60.

Crowns are secured to the upper exterior portion 61 of an abutment 41 in a variety of ways. For example, crowns may be attached with oral cement or screws. Crowns act as aesthetic and functional substitutes to teeth. FIG. 5 shows a cross-sectional view of the crown 60 when it has been fully installed into the mouth of a dental patient. Crowns may be made from many materials, including porcelain, gold, titanium, zirconia, alloys, and combinations thereof. Some crowns are placed after the abutment is secured to the implant fixture. Other crowns are secured to the abutment first (e.g., formed/molded about the abutment or pre-bonded to the abutment). As shown at FIG. 5, the crown 60 is pre-secured to the abutment 41. When the crown 60 is secured to the abutment 41 before the abutment 41 is secured to the implant fixture 42, a through hole 62 may be used to allow the screw 40 to pass through the crown 60 and the abutment 41 to be threaded into the implant fixture 42. In other examples, the screw 40 can thread into the abutment. The through hole 62 may be at least the diameter of the head 67 of the screw 40, such that the head 67 of the screw 40 may pass through the crown 60 and sit on the shoulder 56 of the abutment 41 when fully threaded into the implant fixture 42. Other crowns may have the through hole 62 be at least the diameter of the threaded shank 71 such that the head 67 of the screw 40 sits atop the coronal surface 63 of the crown 60. Generally, the through hole 62 extends from a top coronal surface 63 of the crown 60 to a bottom apical surface 64, such that the bottom apical surface 64 of the crown 60 would contact the top end 52 of the abutment 41 when installed. Also, when installed, the through hole 62 is generally centered on the coronal/apical axis 46, such that a screw 40 may be inserted into the through hole 62 of the crown 60 and continue into the abutment cavity 55 of the abutment 41.

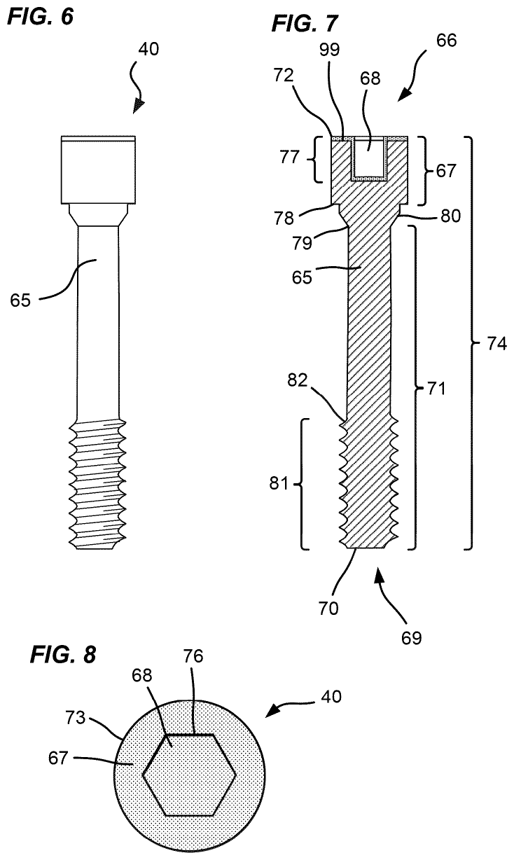

FIGS. 6-8 show the screw 40 of the dental assembly of FIG. 1. Dental screws are commonly made of gold, titanium, or alloys thereof. Screws 40 for dental applications may vary, but in some examples are between 5 mm and 10 mm in length 74. FIG. 7 shows a cross-sectional view of one possible example of the screw 40. The screw 40 has a main body 65 where the main body 65 includes a first end 66 having the head 67. The head 67 also defines a drive socket 68. The main body 65 also has a second end 69 defining a tip 70. The main body 65 also has the shank 71 extending from the head 67 to the tip 70. The screw 40 also has a magnetic element 72.

The main body 65 of the screw 40 may have a material composition of any suitable biocompatible material. Commonly, these screws 40 are made of gold or titanium. In one embodiment, the screw 40 has a material composition including a non-ferromagnetic material such as gold, titanium, or alloys thereof. The main body 65 of the screw 40 may also vary in size and shape.

The shape of the head 67 may vary, for example, the head 67 may be tapered, conical, cylindrical, beveled, stepped, or combinations thereof. FIG. 8 shows a top view of one possible embodiment of the screw 40 where the head 67 has a generally circular top portion 73. The circular top portion 73 may fit within the through hole 62 of the crown 60 and/or the first area 57 of the abutment cavity 55.

Referring to FIGS. 7 and 8, the circular top portion 73 extends from the first end 66 toward the second end 69, along the length 74 of the screw 40 to form a generally cylindrical shape. The cylindrical shape terminates at the bottom end 78. The length of the cylindrical shape may vary but, in certain examples, is between 1.50 mm and 5.0 mm. The diameter of the circular top portion 73 of the head 67 may also vary and, in certain examples, is between 2 mm and 3 mm. When the screw 40 is threaded onto the implant fixture 42, the circular top portion 73 of the head 67 is centered about the coronal/apical axis 46. The length of the head 67 extends along the coronal/apical axis 46.

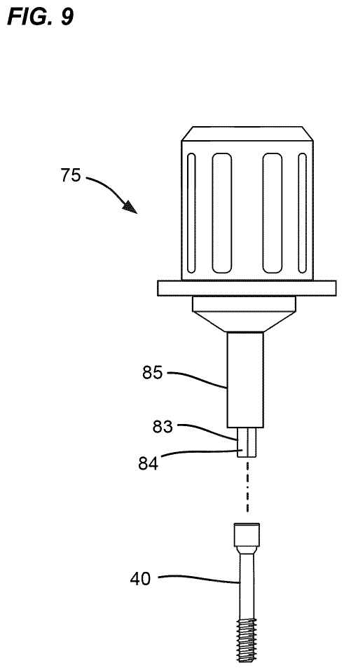

The circular top portion 73 of the head 67 also includes the drive socket 68. The drive socket 68 is intended to facilitate rotation of the screw 40 about the coronal/apical axis 46 in order to thread the screw 40 onto, or off of, the implant fixture 42 with the use of a driver 75. FIGS. 9 and 13 show an example driver 75 in conjunction with the retention screw 40. Returning to FIGS. 7 and 8, the drive socket 68 is generally centered on the center point of the circular top portion 73 of the head 67. The drive socket 68 may form a regular polygonal shaped recess which extends from the circular top portion 73 of the head 67 along the length 74 of the screw 40. Sides 76 of the polygonal shape may also vary in length and number. In one embodiment, the drive socket 68 forms a hexagonal shaped recess. A depth 77 of the drive socket 68 may vary but, in certain examples, is between 1.0 mm and 5.0 mm. For a regular hexagonal shaped drive socket 68, in certain examples the sides 76 of the hexagon range from 0.5 mm to 0.8 mm.

The shank 71 of the screw 40 runs from the bottom end 78 of the head 67 of the screw 40 to the tip 70. The shank 71 forms a generally cylindrical body where a top circular portion 79 is joined to the bottom end 78 of the head 67 such that the center of the top circular portion 79 of the cylindrical body is centered on the bottom end 78 of the cylindrical body of the head 67. There may be a transitional shape 80, like a frustum, running from the bottom end 78 of the head 67 to the top circular portion 79 of the shank 71. When the screw 40 is threaded onto the implant fixture 42, the coronal/apical axis 46 runs through the center of the cylindrical body of the shank 71, such that the center of the cylindrical body of the head 67 and the center of the cylindrical body of the shank 71 are aligned about the coronal/apical axis 46. In certain examples, the shank 71 of the screw 40 has a length between 3 mm and 8 mm. In certain examples, a diameter of the shank 71 is between 0.5 mm and 2.5 mm.

The shank 71 may also include a threaded portion 81 having threads 82. The threaded portion 81 may run along the exterior of the cylindrical body of the shank 71 of the screw 40 in a helical fashion. The threads 82 may be exterior, meaning they extend outward from the body of the shank 71. The threads 82 may run along the entirety of the shank 71 or just a portion. Commonly only the lower, apical portion is threaded to engage the implant fixture 42. In one example, the threaded portion 81 of the shank 71 is 2 mm to 5 mm in length. The threaded portion 81 is depicted extending from the tip 70 of the screw 40 toward the first end 66 in order to facilitate engagement with the threaded cavity 49 of the implant fixture 42.

The tip 70 of the screw 40 defines the bottom apical end of the screw 40. The tip 70 may be flat, pointed, beveled, chamfered, rounded, or otherwise terminated in any way. Commonly, retention screws 40 have a tip 70 with a flat portion generally parallel to the top circular portion 73 of the head 67.

Referring to FIG. 7, the screw 40 may also include a magnetic element 72. The magnetic element 72 forms a magnetic attraction to the magnetic driver 75. The magnetic attraction provides an additional means of retaining the screw 40 to the driver 75 during dental procedures. The magnetic attraction may be enough to hold the screw 40 to the driver 75 on its own or in conjunction with other means, such as frictional forces. The magnetic element 72 may have a magnetic material composition including a magnetic metal or a magnetic metal alloy. Example magnetic material compositions can include magnetic materials such as electromagnetic, ferrimagnetic, or ferromagnetic materials. In one embodiment, the magnetic element 72 is ferromagnetic. Commonly used ferromagnetic metals include nickel, iron, cobalt, and alloys thereof. A skilled artisan will recognize biocompatibility and galvanic corrosion as important considerations in material choice. The magnetic element 72 may be carried with the main body 65. The magnetic element 72 may also encompass the entirety of the screw 40, for example the screw 40 may be made of nickel or stainless steel. In other embodiments the magnetic element 72 may be less than the entirety of the screw 40. For example, the magnetic element 72 may be part of the head 67 of the screw 40.

In one embodiment the magnetic element 72 may be a layer 99 (e.g., a layer formed by plating, coating, or other process) on the surface of the screw 40. For example, FIG. 7 shows the circular top portion 73 of the head 67, including the drive socket 68 as plated by layer 99. Plating metals is common across many industries and is done, for reasons including, to improve corrosion resistance, reduce friction, decorate, or otherwise improve performance. In the present embodiment, a plating of magnetic material may be used to provide magnetic attraction between the screw 40 and the driver 75. For example, a ferromagnetic material such as nickel may be plated onto a gold screw 40 to provide magnetic attraction. The amount of magnetic attraction is proportional to the amount of ferromagnetic material, such that increasing the thickness of a given layer would increase the level of magnetic attraction. The thickness of a plating may vary from as little as a single atomic layer to 0.1 mm or more. In one embodiment, the layer thickness is enough to create sufficient magnetic attraction between the screw 40 and the driver 75, such that the screw 40 may be held by the driver 75 with magnetic attraction alone. The layer thickness required to provide this level of attraction will be referred to as minimum layer thickness. The minimum layer thickness may vary with material choice, plating position, plating area, screw weight, driver attraction, etc.

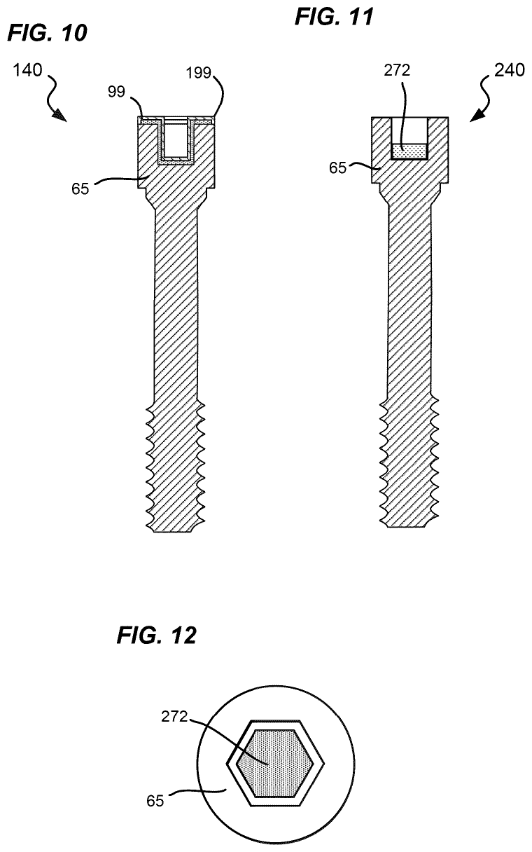

In yet another embodiment, where biocompatibility may be a concern, FIG. 10 shows an alternative screw 140 having the same design as the screw 40, except the layer 99 may be encapsulated below the surface of the screw 40 by an additional layer 199 of the material forming the main body 65. For example, the head 67 of a gold screw 40 may be plated with a minimum layer thickness of nickel and then encapsulated by an additional plating of gold. In this embodiment the benefits of the magnetic element 72 are achieved while mitigating concerns of biocompatibility. The magnetic plating may also be of other suitable magnetic metals, and the additional plating may be a material different from the main body 65.

In yet another embodiment, the main body 65 of the screw 40 may be formed by the magnetic element 72 with a nonferromagnetic surface layer partially or completely covering the exterior of the screw 40. For example, the main body 65 of the screw 40 may be nickel with an exterior surface plating of gold encapsulating the nickel.

FIG. 11 shows an example of another screw 240 having the same design as the screw 40 except the magnetic element 72 is provided as a piece separate from the main body 65 that is fixed within the screw 240 (e.g., inset within the screw). In the present example, the magnetic element 72 is secured as an insert 272 (e.g., a plug, block, etc.) to the bottom of the drive socket 68 of the head 67 so as to be inset within the head 67. For example, the magnetic element insert 272 may be a rare earth magnet, a composite magnet, a magnetic metal, or any other magnetic material. The separate piece may be secured to the screw 40 any number of ways. For example, the magnetic element insert 272 may be glued, friction fit, welded, or otherwise fixed to the screw 40. In one embodiment, the magnetic element 272 is secured to the bottom of the drive socket 68 with an adhesive or press-fit within the socket 68. In another embodiment, the magnetic element 72 is welded to the screw 40 by means of fusion or solid-state welding.

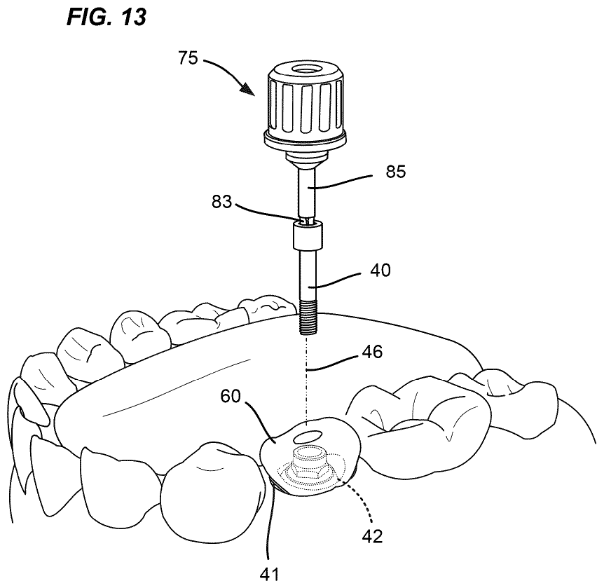

In yet another embodiment, the magnetic element 272 may be removable. For example, the magnetic element 272 may be friction fit or otherwise adhered to the screw 240 such that the magnetic attraction to the driver 75 is insufficient to remove the magnetic element 272 from the screw 40, but after installation in the implant fixture 42, the magnetic element 272 may be removed by a stronger magnetic attraction, such as that created by a rare earth magnet. In this example, the magnetic element 272 may be removed so that corrosion or biocompatibility concerns may be mitigated. FIG. 12 shows a top view of the drive socket 68 where a magnetic element 272 may be inserted or removed.

Once the implant fixture 42 is placed within the jawbone 43, the abutment 41 and screw 40 may be attached. In one embodiment, the screw 40 is placed into the through hole of the crown 60 and moves freely in the apical direction of the coronal/apical axis 46 until the tip 70 reaches the threaded region of the implant fixture 42. The driver 75 is used to thread the screw 40 into the threaded cavity 49 of the implant fixture 42. As the screw 40 is fastened, the apical side of the head 67 becomes seated on the shoulder 56 of the abutment 41, holding the bottom portion 54 of the abutment 41 against the coronal top exterior surface of the implant fixture 42. In another embodiment, the screw 40 is placed into the through hole of the dental structure and threaded onto the implant fixture 42 until the dental structure is fully seated.

FIGS. 9 and 13 show the magnetic driver 75 with the screw 40. The magnetic driver 75 may be used in conjunction with the magnetic element 72 of the screw 40 to help facilitate handling and fastening of the screw 40. There are many ways in which a driver 75 may also be magnetized. For example, a strong ferromagnetic material, such as neodymium, is used in conjunction with a ferromagnetic bit 83, such as an iron alloy bit 83. The strong ferromagnetic material may contact the bit 83 in a number of places. For example, the strong ferromagnetic material may sit at the base of the bit 83, in the handle, as a collar 85 around the bit 83, or even act as the bit 83 itself. FIG. 9 shows one possible example of a magnetic driver 75 using a collar 85. The bit 83 forms a shaped tip 84 which is meant to fit closely into the drive socket 68 of the screw 40. Hexagonal shaped tips 84 are commonly used for retention screws 40. Generally, the shaped tip 84 extends for at least the length of the depth 77 of the drive socket 68 on the screw 40. Retention screws are commonly held onto the tip of drivers with only the frictional force created between the side walls of the tip and the side walls of the drive socket. Through use and wear, the frictional fit between the shaped tip and the drive socket may decrease. As the frictional fit decreases, handling, fastening, and unfastening may become increasingly difficult. Smaller screw sizes add to the difficulty.

The magnetic retention screw 40 in conjunction with the magnetic driver 75 may aid in the handling and fastening of the screw 40. The small size of retention screws 40 makes handling difficult and possibly dangerous if, for example, a retention screw 40 falls into a patient's mouth. One embodiment of the present disclosure is a method of using the magnetic screw 40. For example, a method for handling the screw 40 used to secure a dental structure to an implant fixture 42 within the jawbone 43 of a dental patient, involves inserting the screw 40 into the dental structure within the patient's mouth or removing the screw 40 from the dental structure within the patient's mouth while the screw 40 is retained at the tip 84 of a hand driver 75 at least partially by magnetic attraction between the screw 40 and the tip 84 of the hand driver 75. FIG. 13 shows the driver 75 with the tip 84 inserted into the drive socket 68 of the screw 40 moving along the coronal/apical axis 46 to be inserted into the crown 60 and abutment 41 that is seated on the dental implant fixture 42 within a patients jawbone 43. FIG. 5 shows the screw 40 after being threaded into the implant fixture 42, securing the combined abutment 41 and crown 60. Another possible embodiment of this method is where the screw 40 is recessed within the dental structure as the screw 40 is driven into or from the dental structure. Another embodiment of this method is where the screw 40 is inserted into the dental structure in a coronal to apical direction as defined by the coronal/apical axis 46, or where the screw 40 is removed from the dental structure in an apical to coronal direction.

In some cases, the threading may be partially or completely stripped making removal of the retention screw 40 difficult. In other cases, the drive socket 68 may not frictionally fit the driver tip 84, making handling precarious. Another embodiment of the disclosed method is where the screw 40 may be removed at least partially by magnetic force when the screw 40 is damaged, or otherwise difficult to access. In another embodiment of the disclosed method, the magnetic tip 84 and magnetic element 72 are attracted to each other with sufficient magnetic force to hold the screw 40 at the end of the magnetic tip 84.

Because the dental structures 41, implant fixtures 42, and screws 40 are typically meant to be compatible with each other and used together, a kit may be sold. One embodiment of the present disclosure includes a dental assembly with at least a dental structure, implant fixture 42, and magnetic screw 40. The dental structure may be, for example, the abutment 41. A dental assembly may also include additional items such as a magnetic driver 75. These components may also be sold individually.

The above specification, examples and data provide a complete description of the manufacture and use of the composition of the invention. Since many embodiments of the invention can be made without departing from the spirit and scope of the invention, the invention resides in the claims hereinafter appended.

1. A dental assembly, comprising:
a screw comprising:
a main body having a first end including a head defining a drive socket, the main body also having a second end including a tip, and a shank extending from the head to the tip, wherein at least a portion of the shank is threaded; and
a magnetic element, carried with the main body, the magnetic element making up less than the entirety of the screw, the magnetic element configured to at least partially retain the screw to a tip of a hand driver by magnetic attraction;
an implant fixture configured to be installed into a jawbone of a patient, the implant fixture having a threaded outer region configured to engage the jawbone, the implant fixture having a threaded cavity configured to engage the screw, the entrance to the threaded cavity having a tapered perimeter; and
an implant structure, the implant structure having a tapered outer portion, the implant structure having an unthreaded cavity, the implant structure having a shoulder within the unthreaded cavity configured to contact an underside of the head of the screw;
wherein the screw is configured to pass through the unthreaded cavity of the implant structure until the underside of the head contacts the shoulder, wherein the screw is configured to thread into the implant fixture thereby seating the implant structure such that the tapered perimeter of the implant fixture cavity aligns with the tapered outer portion of the implant structure.

2. A screw for securing a dental structure to an implant fixture within the jawbone of a dental patient, the screw comprising:
a main body having a first end including a head defining a drive socket, the head having a bottom end configured to seat against a shoulder within a cavity of the dental structure, the main body also having a second end including a tip, and a shank extending from the head to the tip, the shank configured to pass through an unthreaded cavity of the dental structure, wherein at least a portion of the shank is threaded and configured to engage a threaded cavity of the implant fixture; and
a magnetic element, carried with the main body, the magnetic element making up less than the entirety of the screw, the magnetic element configured to at least partially retain the screw to a tip of a hand driver by magnetic attraction.

3. The screw of claim 2, wherein the majority of the screw is non-ferromagnetic and includes either gold or titanium.

4. The screw of claim 2, wherein the magnetic element forms a portion of the drive socket and is located entirely within the head.

5. The screw of claim 2, wherein the magnetic element is removable from the drive socket of the screw.

6. The screw of claim 2, wherein the magnetic element is encapsulated by a main body material that is biocompatible and non-ferromagnetic.

7. The screw of claim 2, wherein the shank is non-magnetic.

8. The screw of claim 2, wherein the magnetic element is a surface layer including at least a portion of the drive socket.

9. The screw of claim 2, wherein the distance between the first end and the second end is 10 millimeters or less and the head includes a top surface that is 5 millimeters or less across.

10. A screw for securing a dental structure to an implant fixture within the jawbone of a dental patient, the screw comprising:
a main body having a first end including a head defining a drive socket, the main body also having a second end including a tip, and a shank extending from the head to the tip, wherein at least a portion of the shank is threaded; and
a magnetic element carried with the main body.

11. The screw of claim 10, wherein the magnetic element is a surface layer.

12. The screw of claim 10, wherein the magnetic element is a layer below a surface of the screw.

13. The screw of claim 10, wherein the magnetic element forms a portion of the drive socket.

14. The screw of claim 10, wherein the magnetic element is removable from the drive socket.

15. The screw of claim 10, wherein the magnetic element is fusion welded to the main body.

16. The screw of claim 10, wherein the magnetic element is solid state welded to the main body.

17. The screw of claim 10, wherein the magnetic element has a magnetic material composition.

18. The screw of claim 10, wherein the drive socket forms a hexagonal channel.

19. The screw of claim 10, wherein the main body is non-ferromagnetic.

20. The screw of claim 19, wherein the main body has a material composition including titanium or gold.

21-33. (canceled)
